(19) United States
(12) Patent Application Publication
(10) Pub. No.: US 2016/0347635 A1
(43) Pub. Date: Dec. 1, 2016

(54) DEVICE FOR DISINFECTING WATER USING OZONE AND ULTRAVIOLET LIGHT

(71) Applicant: Egon GRUBER, Graz (AT)

(72) Inventor: Egon GRUBER, Graz (AT)

(21) Appl. No.: 15/112,812

(22) PCT Filed: Jan. 20, 2015
(86) PCT No.: PCT/AT2015/050018

§ 371 Date: Jul. 20, 2016

(30) Foreign Application Priority Data
Jan. 21, 2014 (AT) A 39/2014

(51) Int. Cl. C02F 1/78; E04H 4/12; C02F 1/32

(52) U.S. Cl. CPC C02F 1/78; C02F 1/325; E04H 4/1209; C02F 2103/42

(57) ABSTRACT

The invention relates to a device for disinfecting water of a swimming pool, comprising an inlet for water from the swimming pool, an ozonation device, and a mixing section for ozone-containing water. The ozonation device comprises at least one UV light source (3) for generating ozone and an admixing unit (10) for admixing the generated ozone to the water of the inlet. The mixing section comprises a housing (1) which is connected to the inlet, and the at least one UV light source (3) is arranged on the housing (1) or within the housing (1) so as to emit the UV light into the housing interior. The housing (1) is provided with a transparent panel (11) for visually inspecting the housing interior. According to the invention, the housing (1) forms deflecting surfaces (2) for the water, said surfaces protruding into the housing interior and ensuring a meandering flow within the housing (1). The device according to the invention allows an improved disinfection and can be designed so as to be space-saving and more visually pleasing than conventional devices. Encasements (5) of successive UV light sources (3) are connected to one another via an air flow channel (8).

The invention relates to a device for disinfecting water of a swimming pool, comprising an inlet for water from the swimming pool, an ozonation device, and a mixing section for ozone-containing water, wherein the ozonation device comprises at least one UV light source for generating ozone, and an admixing unit for admixing the generated ozone to the water of the inlet, according to the preamble of claim 1.

The admixing of chlorine-containing disinfecting agents is used for disinfecting water of a swimming pool, especially of so-called whirlpools. The use of ozone is known as an alternative to or in addition of the chlorination of the pool water. Ozone is a highly effective disinfecting agent, and in contrast to chlorine it is virtually odourless. Ozone can be formed for example by ultraviolet light (UV light) of suitable frequency in that an air flow is guided past the UV light source in order to split the oxygen molecule contained in the air into elementary oxygen at first and to subsequently form ozone by adding the elementary oxygen to molecular oxygen. This process is realised in terms of apparatus by means of an ozone generator for example, in that the UV light source is surrounded by a gas-tight casing in which the air flow is guided and is subjected to the ultraviolet light. The air flow enriched with ozone then leaves the ozone generator and is supplied to an admixing unit which mixes the air flow enriched with ozone in the inlet to the water to be disinfected. The admixing unit can be formed as a Venturi nozzle for example. The ozone generator is conventionally formed as a separate unit which is connected to the inlet via the admixing unit. The ozone generator with the admixing unit will also be referred to below as an ozonation device. Conventional embodiments of an ozonation device are described for example in U.S. Pat. No. 4,230,571 and WO 2013/155283.

Air bubbles are formed in the water flow after the admixing of the ozone-containing air flow to the water flow, on the surfaces of which the disinfecting action occurs, in that the ozone contained in the air bubble oxidises the impurities contained in the water flow. This process is promoted by good thorough mixing of the air bubbles with the water flow and by reducing the size of the air bubbles. A mixing section therefore follows the admixing unit of the inlet, in which the ozone-containing water is thoroughly mixed so as to support the disinfecting effect of the ozone before the water is supplied to the swimming pool again. The term “ozone-containing water” refers to the water flow after the admixture of the ozone-containing air flow, irrespective of whether the ozone is present within the injected air bubbles in the water flow or is dissolved in the water flow. The mixing section is mostly formed in a conventional manner as an extended hose line, which is rolled up or arranged in a meandering manner to reduce the need for space. It is understood that the disinfecting effect of the ozone also continues after leaving the mixing section as long as sufficient quantities of ozone are present, e.g. in the swimming pool itself, where ozone dissolved in the water will usually degasify and leave the water.

The disinfecting effect of the ozone is unsatisfactory in known configurations, so that additional chlorination usually cannot be avoided. Furthermore, the mixing section which is formed in form of an extended hose line requires a respective amount of space and represents a visually unappealing component of conventional swimming pools. It is a further disadvantage that the proper function of the components provided for disinfection can hardly be verified, so that it is necessary to use indirect parameters such as the pH value of the pool water. In practice however, inadequate disinfection of the pool water is often only determined on the basis of visible impairments to the pool water, i.e. at a point in time where the swimming pool should no longer be used.

It is therefore the object of the invention to provide a device for the disinfection of water of a swimming pool which allows improved disinfection and can be formed in a space-saving and more visually pleasing manner than conventional devices.

These objects are achieved by the features of claim 1. Claim 1 relates to a device for disinfecting water of a swimming pool, comprising an inlet for water from the swimming pool, an ozonation device, and a mixing section for ozone-containing water, wherein the ozonation device comprises at least one UV light source for generating ozone, and an admixing unit for admixing the generated ozone to the water of the inlet, and the mixing section comprises a housing which is connected to the inlet, wherein the at least one UV light source is arranged on the housing or within the housing so as to emit UV light into the housing interior, and the housing is provided with a transparent panel for visually inspecting the housing interior. It is proposed in accordance with the invention that the housing forms deflecting surfaces for the water, said surfaces protruding into the housing interior and ensuring a meandering flow within the housing. The deflecting surfaces protruding into the housing interior allow an extension of the mixing section at given housing dimensions on the one hand and amplify the turbulence of the water flow on the other hand. Both effects improve the contact of the water with ozone and thus the disinfecting effect. The housing thus forms a mixing chamber for the water enriched with ozone. As a result of arranging at least one UV light source on the housing or within the housing with an emission of the UV light into the water-conducting housing interior and thus directed towards the water, the disinfecting effect is amplified because the UV light also acts directly in a disinfecting manner. The UV light source is thus not only used for generating ozone, but also used for the direct disinfection of the water, so that improved disinfection can be achieved at the same electrical power consumption for the operation of the UV light source. Furthermore, the housing is provided with a transparent panel, which allows a visual inspection of the housing interior. It is thus not only possible to check the water flow, i.e. the proper operation of the water circulating pump, but also the formation of bubbles, i.e. the proper function of the air flow guidance and the admixing unit, as well as the correct function of the UV light sources per se, which are arranged on the housing or within the housing, since UV light sources also always emit a visible light component. If the UV light sources operate with normal functionality, sufficient ozone generation can also be assumed. The operating parameters which are relevant for disinfection can thus be checked at a glance, or impurities on the involved components can be determined, especially in the region of the UV light sources.

The at least one UV light source which is arranged within the housing preferably comprises a casing which is arranged on a deflecting surface or forms a portion of the deflecting surface. The UV light source thus protrudes at a small distance from the water flow into the housing interior, so that optimal exposition of the water with UV light is achieved. Furthermore, the entire interior space of the housing is illuminated, so that visual inspection of the housing interior and the UV light sources per se is facilitated. If a sequence of deflecting surfaces which are arranged in parallel and are each provided with a UV light source is further provided within the housing in order to maximise disinfection and the illumination of the housing interior, it is easy to determine in the case of a malfunction of a UV light source which UV light source is subject to this malfunction. The UV light sources are preferably exchangeably mounted in the housing, so that individual UV light sources can easily be removed and replaced.

If several UV light sources are used, the casings of successive UV light sources are preferably connected to each other via an air flow channel, wherein the housing comprises an intake opening for air and a discharge opening which is connected to the admixing unit. The casing concerns the aforementioned gas-tight casing for guiding the air flow. The same air flow is thus guided several times past the UV light sources, so that the air flow is increasingly enriched with ozone until it leaves the housing via the discharge opening and is supplied to the admixing unit. The casing per se is preferably arranged in a water-tight manner within the housing, and the UV light source is exchangeably arranged within the casing. An exchange of the casing can occur without having to empty the housing.

It is further proposed that the housing, at least on the side opposite the transparent panel, is formed in a mirrored manner in the direction of the transparent panel. Illumination of the housing interior is thus improved and the visual inspection of the housing interior is thus facilitated. A visually highly appealing realisation of the mixing section in accordance with the invention can further be realised.

It is further proposed for improving the turbulences that a swirling plate is arranged within the housing, which swirling plate crosses the water flow formed by the deflecting surfaces and is provided with water passage openings in the crossing regions.

The invention will be explained below in closer detail by reference to an embodiment shown in the enclosed drawings, wherein:

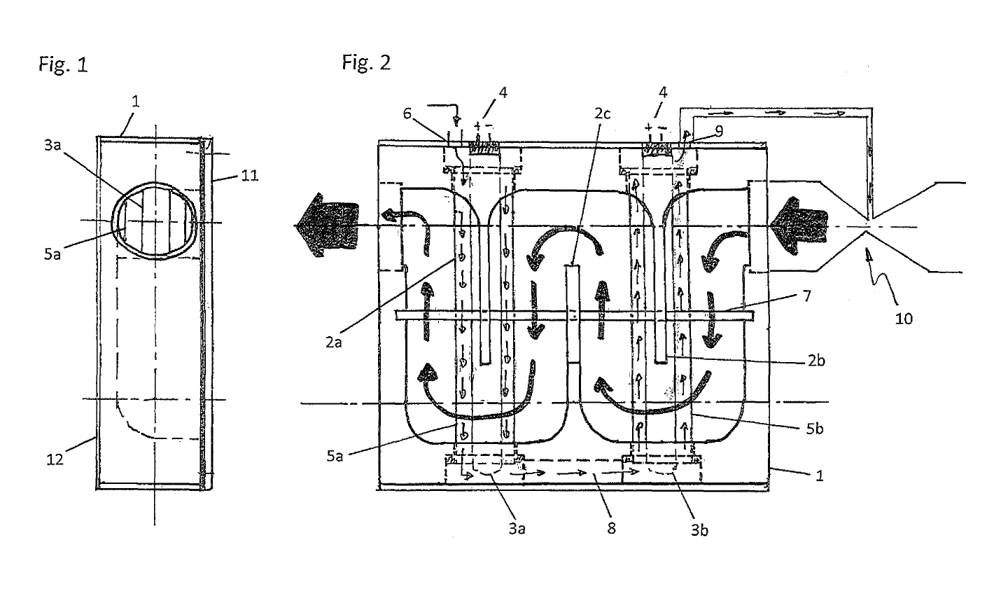

FIG. 1 shows the housing of the device in accordance with the invention shown in FIG. 2 from the left, and

FIG. 2 shows a front view of an embodiment of a device in accordance with the invention.

An embodiment of the device in accordance with the invention is explained by reference to FIGS. 1 and 2. The device comprises a housing 1 with an inlet for the water to be disinfected, which is shown in FIG. 2 in inflow on the right side of the housing 1. The housing 1 forms deflecting surfaces 2a, 2b, 2c in its housing interior, which surfaces can vary with respect to shape and number and ensure a meandering flow for the incoming water within the housing 1 with high turbulence. The progression of the flow is indicated in FIG. 2 with arrows shown in bold print, and represents the mixing section in which a major part of the disinfection of the water occurs. In order to increase the turbulence of the occurring water flow, at least one swirling plate 7 can further be arranged in the housing interior, which swirling plate crosses the water flow formed by the deflecting surfaces 2 and is provided in the crossing regions with water passage openings.

UV light sources 3a, 3b are arranged on the two deflecting surfaces 2a and 2b, which light sources are exchangeably held in an upper cover of the housing 1 and each comprise a power supply 4. The configuration and number as well as the location of the arrangement of the UV light sources 3 can vary. They can thus also be arranged on the lateral inner walls of the housing 1 for example. It is relevant however that they produce an emission of the UV light that is directed into the housing interior, so that an exposition of the water flow guided within the housing 1 is provided by the UV light emitted by the UV light sources 3. The two UV light sources 3a, 3b are further each provided with a gas-tight casing 5a, 5b, which is fixed in a water-proof manner via seals in the upper cover and a bottom cover of the housing 1 and are tightly arranged in a recess of the respective deflecting surface 2. The casings 5a, 5b are formed in an approximately tubular manner and also cross the water flow occurring in the housing interior in the illustrated embodiment, so that the water flows around said casings. The casing 5a, which is shown in FIG. 2 on the left, is further connected to a suction opening 6 arranged on the upper cover of the housing 1, via which ambient air is aspirated and is supplied to the casing 5a. The further progression of the flow is indicated in FIG. 2 with the thin arrows. The aspirated air flows around the left UV light source 3a shown in FIG. 2 and finally reaches the region of the casing 5a which is situated close to the bottom cover of the housing 1 and which is connected via an air flow channel 8 to the bottom region of the right casing 5b shown in FIG. 2. The aspirated air flows in its further progression of flow around the right UV light source 3b shown in FIG. 2 and finally reaches the region of the right casing 5b, which is situated close to the upper cover of the housing 1, is shown in FIG. 2 and is connected to a discharge opening 9 arranged in the upper cover of the housing 1. The aspirated ambient air is increasingly enriched with ozone in the course of this flow section, said ozone being formed as a result of the radiation with the UV light emitted by the UV light sources 3. The air enriched with ozone is supplied via the discharge opening 9 to the admixing unit 10, which can be formed as a Venturi nozzle for example and is only shown schematically in FIG. 2. The air enriched with ozone is supplied via the admixing unit 10 to the water flow in the inlet of the housing 1.

As is shown in FIG. 1, the housing 1 is provided with a transparent panel 11 for the visual inspection of the housing interior. The transparent panel 11 is of sufficient size in order to allow visual inspection of the water flow, the formation of bubbles within the water flow, and the function of the UV light sources 3. In the illustrated embodiment, the transparent panel 11 extends over the entire front surface of the housing 1 and covers the front surface in a water-proof manner. In the illustrated embodiment, the housing is formed in a mirrored manner in the direction of the transparent panel 11 on the side opposite the transparent panel 11, e.g. via a mirrored base plate 12 which forms the rear side of the housing 1. The UV light sources 3 not only support the disinfection of the water but also ensure sufficient illumination of the housing interior in order to enable the aforementioned visual inspection.

The deflecting surfaces 2 protruding into the housing interior allow an extension of the mixing section under given housing dimensions on the one hand and amplify the turbulence of the water flow on the other hand. Both effects improve the contact of the water with ozone and thus the disinfecting effect. The disinfecting effect is amplified by the arrangement of at least one UV light source 3 on the housing 1 or within the housing 1 with an emission of the UV light directed into the housing interior, so that improved disinfection can be produced at the same electrical power consumption for operating the UV light source.

A device for the disinfection of water of a swimming pool is provided by means of the invention which allows improved disinfection and can be arranged in a more space-saving and visually appealing manner than in conventional devices. Furthermore, malfunctions of the device can also be recognised more easily by non-professionals.

1. A device for disinfecting water of a swimming pool, comprising an inlet for water from the swimming pool, an ozonation device, and a mixing section for ozone-containing water, wherein the ozonation device comprises at least one UV light source (3) for generating ozone, and an admixing unit (10) for admixing the generated ozone to the water of the inlet, and the mixing section comprises a housing (1) which is connected to the inlet, wherein the at least one UV light source (3) is arranged on the housing (1) or within the housing (1) so as to emit UV light directed into the housing interior, and the housing (1) is provided with a transparent panel (11) for visually inspecting the housing interior, characterized in that the housing (1) forms deflecting surfaces (2) for the water, said surfaces protruding into the housing interior and ensuring a meandering flow within the housing (1).

2. A device according to claim 1, characterized in that the at least one UV light source (3) which is arranged within the housing (1) comprises a casing (5) which is arranged on a deflecting surface (2) or forms a portion of the deflecting surface (2).

3. A device according to claim 2, characterized in that a sequence of deflecting surfaces (2) which are arranged in parallel and are each provided with a UV light source (3) is provided within the housing (1).

4. A device according to claim 3, characterized in that the casings (5) of successive UV light sources (3) are connected to each other via an air flow channel (8), and the housing (1) comprises an intake opening (6) for air and a discharge opening (9) which is connected to the admixing unit (10).

5. A device according to one of the claims 2 to 4, characterized in that the casing (5) of the at least one UV light source (3) which is arranged within the housing (1) is arranged in a water-proof manner within the housing (1), and the UV light source (3) is exchangeably arranged within the casing (5).

6. A device according to one of the claims 1 to 5, characterized in that the housing (1) is formed in a mirrored manner in the direction of the transparent panel (11) at least on the side opposite the transparent panel (11).

7. A device according to one of the claims 1 to 6, characterized in that a swirling plate (7) is arranged within the housing (1), said swirling plate crossing the water flow formed by the deflecting surfaces (2) and being provided with water passage openings in the crossing regions.

8. A swimming pool with a device for the disinfection of water of the swimming pool according to one of the claims 1 to 7.
